(19) United States
(12) Patent Application Publication
(10) Pub. No.: US 2013/0249885 A1
(43) Pub. Date: Sep. 26, 2013

(54) DISPLAY DEVICES, SENSING CIRCUITS AND METHODS FOR SENSING AND COMPENSATING FOR THRESHOLD VOLTAGE SHIFT OF TRANSISTOR

(71) Applicant: INNOLUX CORPORATION, Miao-Li County (TW)

(72) Inventor: Du-Zen PENG, Miao-Li County (TW)

(73) Assignee: InnoLux Corporation, Miao-Li County (TW)

(21) Appl. No.: 13/804,595

(22) Filed: Mar. 14, 2013

(30) Foreign Application Priority Data
Mar. 26, 2012 (TW) 101110320

(51) Int. Cl. G09G 5/00

(52) U.S. Cl. CPC G09G 5/00
USPC 345/212

(57) ABSTRACT

A display device includes a pixel array and a sensing circuit. The pixel array includes multiple active display pixels and at least one dummy display pixel. The active display pixels and the dummy display pixel respectively include a transistor. The sensing circuit is coupled to the transistor of the dummy display pixel for sensing a voltage at the transistor and generates a trigger signal according to the sensed voltage, where a voltage generating device in the display system generates or adjusts a first control voltage according to the trigger signal and the transistors of the active display pixels and the dummy display pixel are turned off in response to the first control voltage.

### CROSS REFERENCE TO RELATED APPLICATIONS

This application claims priority of Taiwan Patent Application No. 101110320, filed on Mar. 26, 2012, the entirety of which is incorporated by reference herein.

### BACKGROUND OF THE INVENTION

1. Field of the Invention

The invention relates to a display device, and more particularly to a display device capable of sensing and compensating for a threshold voltage shift of a transistor.

2. Description of the Related Art

Metal Oxide Thin Film Transistor (MOTFT) has become a popular choice when manufacturing a display panel in recent years because the cost is lower than Low Temperature Poly-silicon (LTPS) TFT and the performance is better than the Amorphous Silicon (a-Si) TFT.

However, one drawback of the MOTFT is poor stability. When a display panel is functioning, positive and negative voltages are repeatedly applied to a gate of the MOTFT for turning on or off the MOTFT. After a long period of operation, the stress repeatedly applied to the gate of the MOTFT causes the threshold voltage of the MOTFT to gradually decrease, which may cause the MOTFT to finally have a negative threshold voltage.

FIG. 1 shows a current-voltage characteristic curve of a MOTFT, where the X axis represents the gate-source voltage V_{GS} and the Y axis represents the drain current I_{D}. The curve 10 is an original characteristic curve of a MOTFT, and the curve 20 is a measured characteristic curve of the MOTFT after a long period of operation. According to the curve 10, the original threshold voltage of the MOTFT is Vₜₕ=V_{GS1}, which is a small positive voltage. Therefore, for operating the display panel, the system high voltage may be designed as a positive voltage (for example, 10V) higher than the threshold voltage Vₜₕ for turning on the MOTFT and the system low voltage may be designed as a negative voltage (for example, −3V) for turning off the MOTFT.

However, after a long operation period, the threshold voltage Vₜₕ is shifted from V_{GS1} to V_{GS2}, which is a negative voltage (for example, −5V). The voltage shift of the threshold voltage causes the MOTFT to be unable to be turned off normally by the system low voltage, resulting in malfunction of the display panel.

Therefore, a novel display device capable of sensing and compensating for a threshold voltage shift of a transistor to solve the above-mentioned problems is highly required.

### BRIEF SUMMARY OF THE INVENTION

Display devices, sensing circuits and methods for sensing and compensating for threshold voltage shift of a transistor are provided. An exemplary embodiment of a display device comprises a pixel array and a sensing circuit. The pixel array comprises a plurality of active display pixels and at least one dummy display pixel. The active display pixels and the dummy display pixel respectively comprise a transistor. The sensing circuit is coupled to the transistor of the dummy display pixel for sensing a voltage at the transistor of the dummy display pixel and generating a trigger signal according to the sensed voltage. A voltage generating device generates or adjusts a first control voltage according to the trigger signal and the transistors of the active display pixels and the dummy display pixel are turned off in response to the first control voltage.

An exemplary embodiment of a sensing circuit comprises a constant current source, a voltage sensing device and a converting device. The constant current source is coupled to a first electrode of a transistor of a dummy display pixel. The dummy display pixel is comprised in a pixel array. The voltage sensing device is coupled to the first electrode of the transistor of the dummy display pixel for sensing a voltage at the first electrode when the transistor is turned on and generating a sensed signal according to the voltage. The converting device is coupled to the voltage sensing device for generating a trigger signal according to the sensed signal. A voltage generating device generates or adjusts a first control voltage according to the trigger signal and a plurality of transistors of a plurality of active display pixels and the transistor of the dummy display pixel in the pixel array are turned off in response to the first control voltage.

An exemplary embodiment of a method for sensing and compensating for threshold voltage shift of a transistor comprises: providing a constant current source to a first electrode of a transistor in a dummy display pixel of a pixel array when the transistor is turned on for sensing a voltage at the first electrode of the transistor and generating a trigger signal according to the voltage; and adjusting a level of a first control voltage according to the trigger signal. The pixel array further comprises a plurality of active display pixel, each active display pixel comprises a transistor, and the transistors of the active display pixels and the transistor of the dummy display pixel are turned off in response to the first control voltage.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a current-voltage characteristic curve of a MOTFT;

FIG. 2 shows one of the various types of display devices of the invention according to an embodiment of the invention;

FIG. 3 shows a portion of a display panel according to an embodiment of the invention;

FIG. 4 shows a block diagram of a sensing circuit according to an embodiment of the invention;

FIG. 5 is a circuit diagram of a voltage sensing device according to an embodiment of the invention; and

FIG. 6 is a flow chart of a method for sensing and compensating for threshold voltage shift of a transistor according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

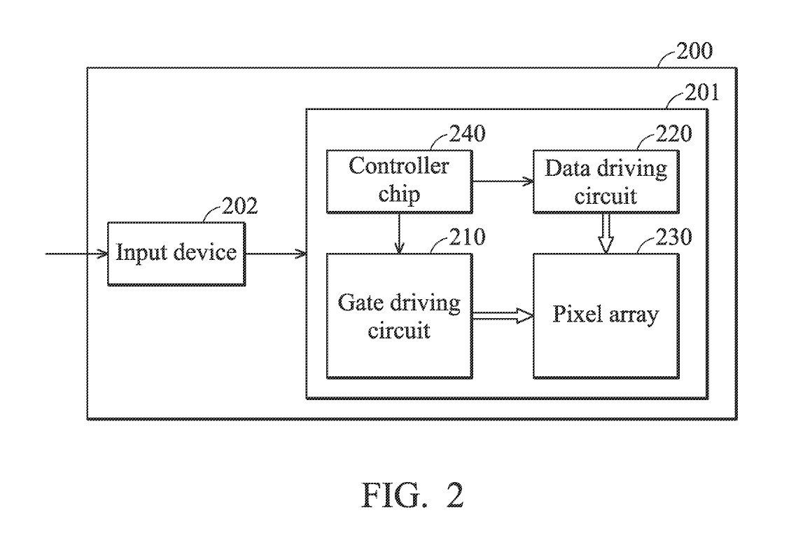

FIG. 2 shows one of the various types of display devices of the invention according to an embodiment of the invention. As shown in FIG. 2, the display device may comprise a display panel 201, where the display panel 201 may comprise a gate driving circuit 210, a data driving circuit 220, a pixel array 230 and a controller chip 240. The gate driving circuit 210 generates a plurality of gate driving signals to drive a plurality of display pixels in the pixel array 230. The data driving circuit 220 generates a plurality of data driving signals to provide data to the display pixels of the pixel array 230. The controller chip 240 generates a plurality of timing signals, comprising clock signals, a system reset signal and a start pulse, and so on, and a plurality of control voltages for controlling operations of the display panel 201.

In addition, the display device of the invention may further be comprised in an electronic device 200. The electronic device 200 may comprise the above-mentioned display panel 201 and an input device 202. The input device 202 receives image signals and controls the display panel 201 to display images. According to an embodiment of the invention, the electronic device 200 may be implemented as various devices, comprising: a mobile phone, a digital camera, a personal digital assistant (PDA), a lap-top computer, a personal computer, a television, a vehicle displayer, a portable DVD player, or any apparatus with image display functionality.

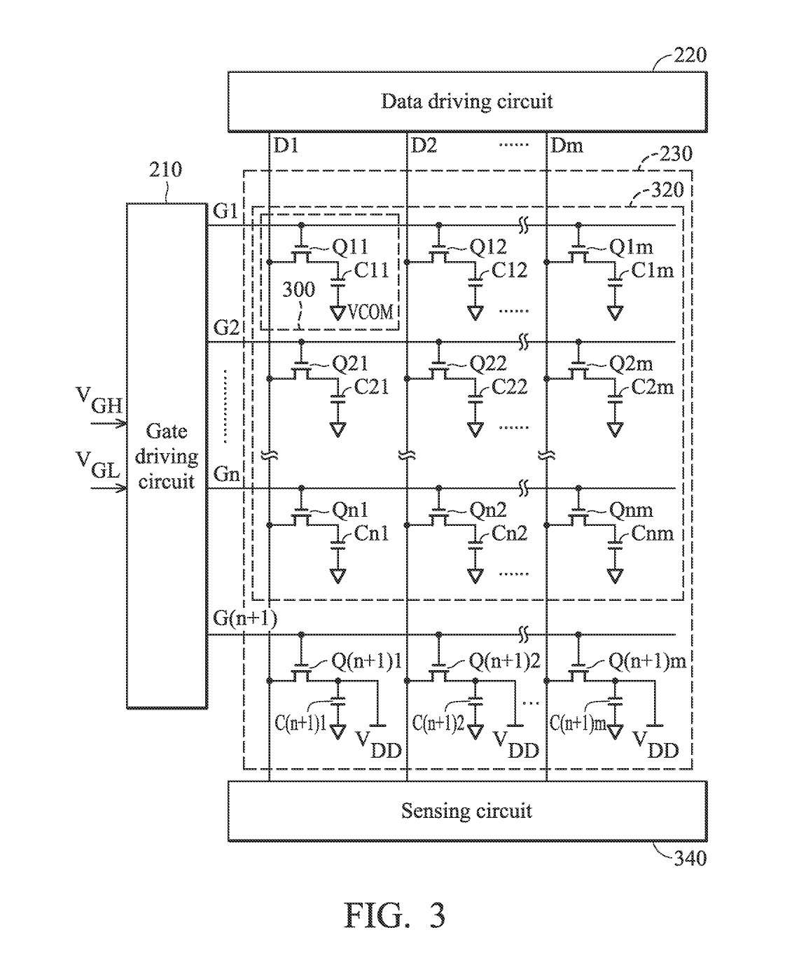

According to an embodiment of the invention, the proposed display device is capable of sensing and compensating for threshold voltage shift of the transistor. FIG. 3 shows a portion of a display panel according to an embodiment of the invention. As shown in FIG. 3, the pixel array 230 comprises a plurality of display pixels, such as display pixel 300. Each pair of interlacing data electrodes (represented by D1, D2, D3, . . . , Dm) and gate electrodes (represented by G1, G2, G3, . . . , Gn+1) controls a display pixel 300. As shown in the figure, an equivalent circuit of the display pixel 300 comprises a transistor (such as the transistors Q11-Q1m, Q21-Q2m, . . . , and Q(n+1)1-Q(n+1)m) for controlling data input and a storage capacitor (such as the capacitors C11-C1m, C21-C2m, . . . , and C(n+1)1-C(n+1)m). According to an embodiment of the invention, the transistors Q11-Q1m, Q21-Q2m, . . . , and Q(n+1)1-Q(n+1)m may be the Metal Oxide Thin Film Transistors (MOTFTs) formed by Indium Gallium Zinc Oxide (IGZO).

Note that in the embodiment of the invention, the display pixel 300 may be an active display pixel or a dummy display pixel. The active pixels are the display pixels disposed in the active area (AA) 320, where each display pixel 300 in the active area 320 may correspond to a brightening point on the pixel array 230. That is, each display pixel 300 corresponds to a single pixel for a monochromatic display or a single sub-pixel for a color display. The sub-pixel can be red (represented by “R”), blue (represented by “B”), or green (represented by “G”). In other words, a single pixel is formed by an RGB (three display pixels) combination.

On the other hand, the display pixels 300 disposed outside of the active area 320 are the dummy display pixels. According to an embodiment of the invention, the electronic components comprised in the dummy display pixels Q(n+1)1˜Q(n+1)m may be almost the same as those comprised in the active display pixel, except for the way in which the power source is coupled thereto (which will be discussed in more detail in the following paragraphs). In addition, in the embodiments of the invention, when the display panel 201 operates, the transistors in the dummy display pixels Q(n+1)1˜Q(n+1)m may be turned on or off according to the corresponding gate driving signals. The difference between the active display pixels and dummy display pixels is that even if the transistors of the dummy display pixels are turned on, the crystal will not be twisted. For example, the Indium Gallium Zinc Oxide (IGZO) may not be electroplated when processing the dummy display pixels Q(n+1)1˜Q(n+1)m, or the common voltage VCOM may not be supplied to the dummy display pixels Q(n+1)1˜Q(n+1)m, or others, so that the crystal on the dummy display pixels Q(n+1)1˜Q(n+1)m will not be twisted. Note that one of ordinary skilled in the art would recognize that there are still many different ways for manufacturing the dummy display pixels Q(n+1)1˜Q(n+1)m, and the invention should not be limited to those mentioned.

According to an embodiment of the invention, the dummy display pixels Q(n+1)1˜Q(n+1)m of the pixel array 230 may further be coupled to a sensing circuit 340. The sensing circuit 340 may sense a voltage at the transistor of the dummy display pixels Q(n+1)1˜Q(n+1)m and generate a trigger signal S_{TRI} according to the sensed voltage, wherein the amount of change in the sensed voltage reflects the amount of threshold voltage shift. A voltage generating device 450 in the display device may further generate or adjust a control voltage V_{GL} (which will be discussed in more detail in the following paragraphs) according to the trigger signal S_{TRI} and the gate driving circuit 210 may receive the control voltage V_{GL} for turning off the transistors 401 in the active display pixels and the dummy display pixels Q(n+1)1˜Q(n+1)m.

According to some embodiments of the invention, the sensing circuit 340 may be integrated in the controller chip 240 and may periodically (for example, every multiple frames) or aperiodically enter a sensing mode in response to a control command received from the controller chip 240 for sensing the voltage change of the transistor in the dummy display pixels Q(n+1)1˜Q(n+1)m. Note that in some other embodiments of the invention, the sensing circuit 340 may also be an independent circuit or may be integrated with other devices or circuits in the display device. Therefore, the invention should not be limited to any specific embodiment.

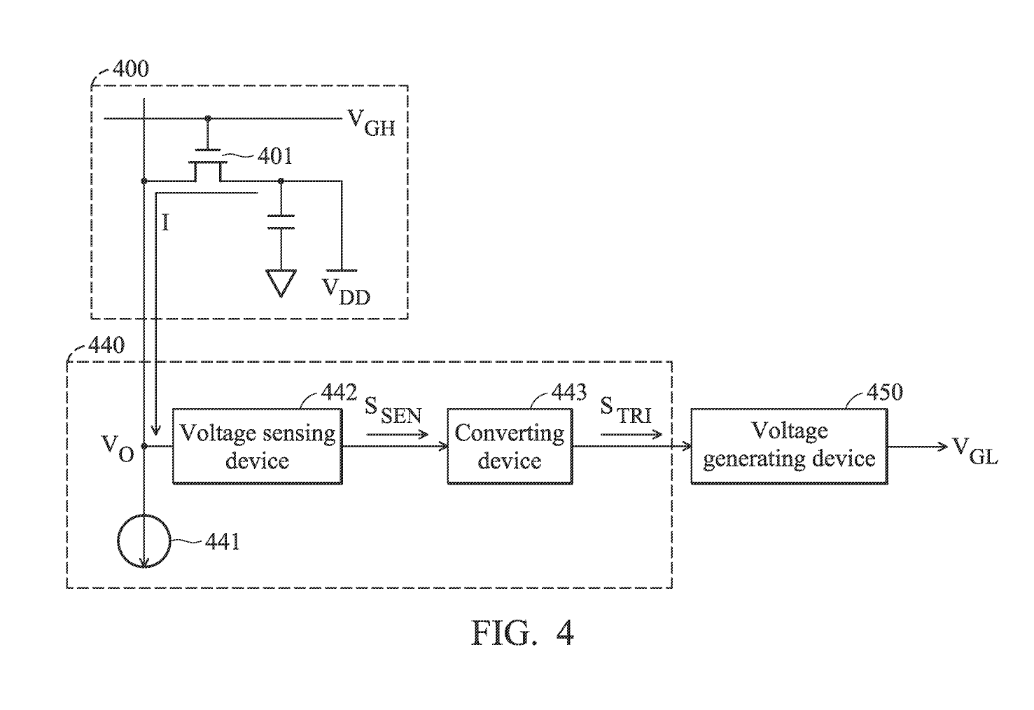

In addition, it is noted that although a raw of dummy display pixels Q(n+1)1˜Q(n+1)m disposed under the active area 320 is shown in FIG. 3, the invention should not be limited thereto. According to a concept of the invention, as shown in FIG. 4, even if there is only one dummy display pixel 400 disposed in the pixel array 230, the sensing circuit 440 may still sense the voltage change of the transistor through the dummy display pixel 400. Referring back to FIG. 3, when there are multiple dummy display pixels Q(n+1)1˜Q(n+1)m disposed on the pixel array 230, the sensing circuit 340 may sense the voltage change through different dummy display pixels Q(n+1)1˜Q(n+1)m in turn, or may take an average of the sensed voltage changes obtained from different dummy display pixels Q(n+1)1˜Q(n+1)m and the invention should not be limited to any specific embodiment.

In addition, it should be further noted that in the embodiments of the invention, the dummy display pixels are not limited to be disposed under the active area 320. In other words, the dummy display pixels may also be disposed above the active area 320, or on the left or right hand side of the active area 320. Therefore, the invention should not be limited to any specific embodiment.

FIG. 4 shows a block diagram of a sensing circuit according to an embodiment of the invention. For brevity, in the embodiment of the invention, the sensing circuit 440 is only coupled to a dummy display pixel 400. As shown in the figure, the sensing circuit 440 may comprise a constant current source 441, a voltage sensing device 442 and a converting device 443. The constant current source 441 is coupled to a first electrode of the transistor 401. The voltage sensing device 442 is also coupled to the first electrode of the transistor 401 for sensing the voltage V_{O} at the first electrode when the transistor 401 is turned on and generating a sensed signal S_{SEN} according to the voltage V_{O}. The converting device 443 is coupled to the voltage sensing device 442 for or generating a trigger signal S_{TRI} according to the sensed signal S_{SEN}. The trigger signal S_{TRI} may be input to a voltage generating device 450 in the display device, wherein the voltage generating device 450 generates or adjusts the control voltage V_{GL} according to the trigger signal S_{TRI}.

The gate driving circuit 210 receives the control voltage V_{GL} from the voltage generating device 450 and receives another control voltage V_{GH} from another voltage generating device (not shown) for controlling the voltage level on each gate line so as to turn on or off the corresponding transistor according to the control voltages V_{GL} and V_{GH}. According to an embodiment of the invention, the voltage generating device may be the regulators inside of the controller chip 240 for generating and providing the control voltages V_{GL} and V_{GH}.

According to an embodiment of the invention, a second electrode of the transistor 401 in the dummy display pixel 400 is coupled to a gate line for receiving the control voltages V_{GL} and V_{GH}, and a third electrode of the transistor 401 is coupled to another control voltage. According to an embodiment of the invention, the control voltage coupled to the third electrode of the transistor 401 may be a high operation voltage of the display panel, such as the voltage V_{DD}. In addition, because the sensing circuit 440 senses the voltage V_{O} at the first electrode of the transistor 401 when the transistor 401 is turned on, the second electrode of the transistor 401 shown in FIG. 4 is directly coupled to the control voltage V_{GH} to represent that the transistor 401 is being turned on.

According to the concept of the invention, because the dummy display pixel is coupled to the active gate line as the active display pixels, the amount of time that the transistor of the dummy display pixel being turned on or off equals to that of the active display pixel. Therefore, under the same operation environment, when the threshold voltage of the transistor in the active display pixel starts to drift, the threshold voltage of the transistor in the dummy display pixel starts to drift, too. In this manner, once the sensing circuit coupled to the dummy display pixel detects the voltage change (as discussed above, the amount of change in the sensed voltage reflects the amount of threshold voltage shift), the sensed amount of voltage change may be reflected on the trigger signal so as to accordingly adjust the control voltage V_{GL}. Because of the adjustment, even if the threshold voltage shift happens, the transistor in the display pixels (either active or dummy) may still be successfully turned off according to the adjusted control voltage V_{GL}.

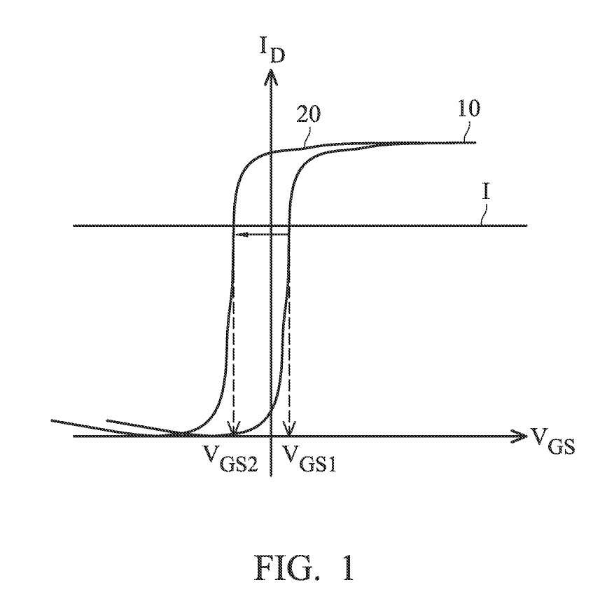

As shown in the figure, because the second and third electrode of the transistor 401 are respectively coupled to a constant voltage (the V_{GH} and V_{DD} as shown), and a constant current source 441 is provided by the sensing circuit 440, the voltage V_{O} at the first electrode of the transistor may be determined according to the amount of current of the constant current source 441. Referring back to FIG. 1, it is noted that there is only one intersection point for each characteristic curve with the constant current I. Therefore, when the constant current I is provided, a corresponding voltage V_{GS} may be obtained for each characteristic curve. Suppose that the first electrode of the transistor is the drain of the transistor, when the constant current is provided, the voltage at the first electrode may be V_{O}=V_{GH}−V_{GS}.

Because the voltage V_{GH} is a constant voltage, from the equation shown above, when the threshold voltage of the transistor changes, the voltage V_{O} at the first electrode changes, accordingly. In other words, the voltage V_{O} at the first electrode varies with the threshold voltage of the transistor. Once the sensing circuit detects that the voltage V_{O} has been changed, the sensing circuit may reflect the amount of change on the trigger signal S_{TRI} so that the voltage generating device 450 may regenerate or adjust the control voltage V_{GL} according to the trigger signal S_{TRI}. The gate driving circuit 210 may receive the adjusted control voltage V_{GL} from the voltage generating device 450 and therefore, the corresponding transistor may be successfully turned off in response to the adjusted control voltage V_{GL}.

According to an embodiment of the invention, the voltage sensing device 442 may be an analog to digital converter for converting the sensed voltage V_{O} into a digital sensed signal S_{SEN}. The converting device 443 may be a Look-Up Table (LUT) device for outputting a corresponding trigger signal S_{TRI} according to the input sensed signal S_{SEN}.

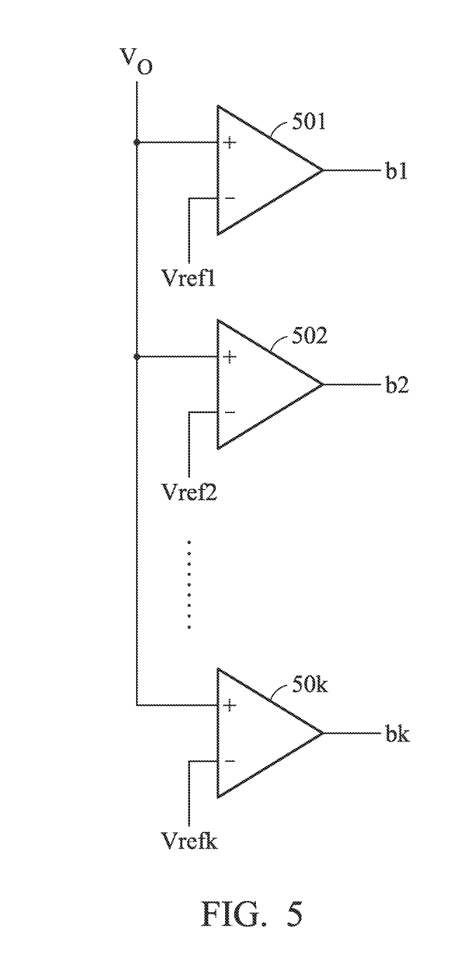

According to another embodiment of the invention, the voltage sensing device 442 may also comprise a plurality of comparators for converting the sensed voltage V_{O} into a digital sensed signal S_{SEN}. FIG. 5 is a circuit diagram of a voltage sensing device according to an embodiment of the invention. The comparators 501-50k are arranged to compare the sensed voltage V_{O} with a plurality of reference voltages Vref1-Vrefk to generate a plurality of comparison results, such as the bits b1- bk shown in FIG. 5. The sensed signal S_{SEN} may be a signal composed by the bits b1-bk. The converting device 443 may be a Look-Up Table (LUT) device for outputting a corresponding trigger signal S_{TRI} according to the input sensed signal S_{SEN}.

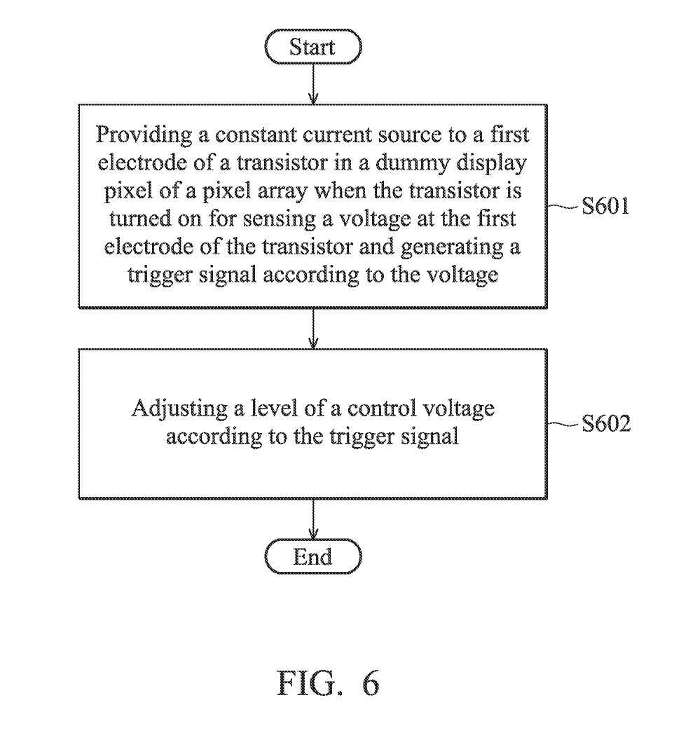

FIG. 6 is a flow chart of a method for sensing and compensating for threshold voltage shift of a transistor according to an embodiment of the invention. First of all, a constant current source is provided to a first electrode of a transistor in a dummy display pixel of a pixel array when the transistor is turned on for sensing a voltage at the first electrode of the transistor and generating a trigger signal according to the voltage (Step S601). Next, a level of a control voltage V_{GL} is adjusted according to the trigger signal (Step S602).

Based on the concept of the invention, the threshold voltage shift of a transistor may be sensed and compensated for without using a complicated circuit layout. In addition, the circuit introduced above may be compatible with conventional display panels. In other words, the circuit introduced above may be directly combined with the driving circuit and peripheral circuit in a conventional display panel without causing any effect thereto. In addition, because the threshold voltage shift is sensed through the dummy display pixel(s), the sensing operations will not degrade the performance of the display panel, and the extra sensing circuit will also not shrink the aspect ratio of the display panel. In addition, the introduced sensing and compensating operations may be performed any time after the display panel is powered on and a period or a time of entering the sensing mode to sense the voltage may be set via the control command of the controller chip 240. In other words, there is no need to frequently perform the sensing and compensating operations during every frame, thus, power consumption can be greatly reduced.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display device, comprising:
a pixel array having pixels arranged in a matrix form, comprising a plurality of active display pixels and at least one dummy display pixel, wherein the active display pixels and the dummy display pixel respectively comprise a transistor; and
a sensing circuit, coupled to the transistor of the dummy display pixel for sensing a voltage at the transistor of the dummy display pixel and generating a trigger signal according to the sensed voltage, wherein a voltage generating device generates or adjusts a first control voltage according to the trigger signal and the transistors of the active display pixels and the dummy display pixel are turned off in response to the first control voltage.

2. The display device as claimed in claim 1, further comprising a display panel, wherein the display panel comprises:
a gate driving circuit, for generating a plurality of gate driving signals for driving the pixel array;
a data driving circuit, for generating a plurality of data driving signals to provide data to the pixel array; and
a controller chip, for controlling operations of the display panel.

3. The display device as claimed in claim 2, wherein the sensing circuit is integrated in the controller chip.

4. The display device as claimed in claim 1, wherein the transistor of the dummy display pixel comprises a first electrode coupled to a constant current source, a second electrode coupled to the first control voltage or a second control voltage and a third electrode coupled to a third control voltage, and the first control voltage and the second control voltage controls an on/off status of the transistor.

5. The display device as claimed in claim 4, wherein the third control voltage is a high operation voltage of the display panel.

6. The display device as claimed in claim 4, wherein the sensing circuit comprises:
the constant current source;
a voltage sensing device, coupled to the first electrode of the transistor of the dummy display pixel for sensing a voltage at the first electrode when the transistor is turned on and generating a sensed signal according to the voltage; and
a converting device, coupled to the voltage sensing device for generating the trigger signal according to the sensed signal.

7. The display device as claimed in claim 6, wherein the voltage sensing device is an analog to digital converter and the converting device is a Look-Up Table (LUT) for outputting the trigger signal according to the sensed signal.

8. The display device as claimed in claim 6, wherein the voltage sensing device comprises a plurality of comparators to compare the voltage with a plurality of reference voltages to generate a plurality of comparison results and generate the sensed signal according to the comparison results, and the converting device is a Look-Up Table (LUT) for outputting the trigger signal according to the sensed signal.

9. The display device as claimed in claim 1, wherein the transistors of the active display pixels and the dummy display pixels are the Metal Oxide Thin Film Transistors (MOTFTs) formed by Indium Gallium Zinc Oxide (IGZO).

10. The display device as claimed in claim 4, wherein the second electrode is coupled to a gate line for receiving the first control voltage.

11. The display device as claimed in claim 4, wherein the second electrode is coupled to a gate line for receiving the second control voltage, and the second control voltage is a constant voltage.

12. A sensing circuit, comprising:
a constant current source, coupled to a first electrode of a transistor of a dummy display pixel, wherein the dummy display pixel is comprised in a pixel array;
a voltage sensing device, coupled to the first electrode of the transistor of the dummy display pixel for sensing a voltage at the first electrode when the transistor is turned on and generating a sensed signal according to the voltage; and
a converting device, coupled to the voltage sensing device for generating a trigger signal according to the sensed signal, wherein a voltage generating device generates or adjusts a first control voltage according to the trigger signal and a plurality of transistors of a plurality of active display pixels and the transistor of the dummy display pixel in the pixel array are turned off in response to the first control voltage.

13. The sensing circuit as claimed in claim 12, wherein the voltage sensing device is an analog to digital converter and the converting device is a Look-Up Table (LUT) for outputting the trigger signal according to the sensed signal.

14. The sensing circuit as claimed in claim 12, wherein the voltage sensing device comprises a plurality of comparators to compare the voltage with a plurality of reference voltages to generate a plurality of comparison results and generate the sensed signal according to the comparison results, and the converting device is a Look-Up Table (LUT) for outputting the trigger signal according to the sensed signal.

15. A method for sensing and compensating for threshold voltage shift of a transistor comprising:
providing a constant current source to a first electrode of a transistor in a dummy display pixel of a pixel array when the transistor is turned on for sensing a voltage at the first electrode of the transistor and generating a trigger signal according to the voltage; and
adjusting a level of a first control voltage according to the trigger signal,
wherein the pixel array further comprises a plurality of active display pixel, each active display pixel comprises a transistor, and the transistors of the active display pixels and the transistor of the dummy display pixel are turned off in response to the first control voltage.

16. The method as claimed in claim 15, wherein a second electrode and a third electrode of the transistor of the dummy display pixel are coupled to a constant voltage, respectively.

17. The method as claimed in claim 15, wherein the transistors of the active display pixels and the dummy display pixel are the Metal Oxide Thin Film Transistors (MOTFTs) formed by Indium Gallium Zinc Oxide (IGZO).

18. The method as claimed in claim 15, further comprising:
generating a sensed signal according to the voltage, wherein the sensed signal is a digital signal; and
generating the trigger signal according to the sensed signal.

19. The method as claimed in claim 18, further comprising:
comparing the voltage with a plurality of reference voltages to generate a plurality of comparison results; and
generating the sensed signal according to the comparison results.

20. The method as claimed in claim 15, wherein the voltage varies with voltage shift of the threshold voltage of the transistor.
